(19) United States
(12) Patent Application Publication
(10) Pub. No.: US 2002/0162605 A1
(43) Pub. Date: Nov. 7, 2002

(54) Bulk metallic glass medical instruments, implants, and methods of using same

(76) Inventors: Joseph A. Horton JR., Oak Ridge, TN (US); Douglas E. Parsell, Ridgeland, MS (US)

Correspondence Address: UT-Battelle, LLC, 111 Union Valley Rd., PO Box 2008, Mail Stop 6498, Oak Ridge, TN, 37831, US

(21) Appl. No.: 09/799,445

(22) Filed: Mar. 5, 2001

(51) Int. Cl. H01F 1/04; H01F 1/16; C22C 1/00

(52) U.S. Cl. 148/304; 148/403; 148/300

(57) ABSTRACT

MRI-compatible medical instruments and appliances are made using bulk metallic glass alloys. MRI-guided methods include the use of articles that include bulk metallic glass alloys.

This invention was made with Government support under Contract No. DE-AC05-00OR22725 awarded by the United States Department of Energy. The Government has certain rights in the invention.

### FIELD OF THE INVENTION

The present invention relates to medical, surgical, and dental hardware, especially medical instruments and biomedical appliances, and particularly to those instruments and appliances at least partially constructed of a bulk metallic glass (BMG), and to methods of using the same.

### BACKGROUND OF THE INVENTION

The concept of magnetic susceptibility is central to many current research and development activities in magnetic resonance imaging (MRI). For example, the development of MR-guided surgery has created a need for surgical instruments and other devices with susceptibility tailored to the MR environment; susceptibility effects can lead to position errors of up to several millimeters in MR-guided stereotactic surgery; and the variation of magnetic susceptibility on a microscopic scale within tissues contributes to MR contrast and is the basis of functional MRI. The magnetic aspects of MR compatibility are discussed in terms of two levels of acceptability: Materials with the first kind of magnetic field compatibility are such that magnetic forces and torques do not interfere significantly when the materials are used within the magnetic field of the scanner; materials with the second kind of magnetic field compatibility meet the more demanding requirement that they produce only negligible artifacts within the MR image and their effect on the positional accuracy of features within the image is negligible or can readily be corrected. Several materials exhibiting magnetic field compatibility of the second kind have been studied and a group of materials that produce essentially no image distortion, even when located directly within the imaging field of view, is identified. Because of demagnetizing effects, the shape and orientation, as well as the susceptibility, of articles within and adjacent to the imaging region is important in MRI, but the use of literature values for the susceptibility of materials is often difficult because of inconsistent traditions in the definitions and units used for magnetic parameters—particularly susceptibility.

Thus, methods and apparatus have long been sought to permit surgical procedures involving surgical instruments and/or surgically implanted appliances to be guided or monitored by MRI.

For this to be possible, a new implant material has long been needed which has a low MRI signature. In addition, it would be desirable for such materials to also have high hardness, tensile strength, and toughness. A desirable material would have a lower elastic modulus and an extremely high elastic limit of about 2% compared to that of a typical metal, namely about 0.2%. Bone has an elastic limit of about 1%. Such material would be unique in its ability to flex elastically with the natural bending of the bones and so distribute stresses more uniformly. Faster healing rates would result from reduced stress shielding effects while minimizing stress concentrators. Because of these unique mechanical properties, screws could have a thinner shank and deeper threads yielding greater holding power. Applications where such material is desirable would include such as fracture fixation screws, rods, pins, knee and hip joint wear surfaces and shafts, and aneurysm clips. A large variety of other applications, changes and modifications would be obvious to those skilled in the art.

Current implant materials produce a distortion or blooming (enlargement) in the MRI image. Larger implants are even internally heated during an MRI. This is especially important for aneurysm clips where later imaging is often needed and where no movement of the clip as a result of an MRI is essential.

Definitions

A bulk metallic glass (BMG) is defined for purposes herein as an amorphous metallic alloy that is cast in bulk form. A BMG is known to be inclusive of amorphous thin-film materials such as those that are typically deposited on surfaces.

A medical instrument is defined for purposes herein as any device used by medical and/or dental personnel in any surgical and/or dental procedure.

A biomedical appliance is defined for purposes herein as any medically functional device that is configured for disposition on or inside a living body, including surgically implanted orthopedic devices, dental implants, and the like.

### OBJECTS OF THE INVENTION

Accordingly, objects of the present invention include at least the following:

provision of new and improved medical instruments and biomedical appliances having at least one of: desirably high elastic limit, hardness, strength, toughness, and ability to hold a cutting edge;

provision of new and improved MRI-compatible medical instruments and surgically implantable orthopedic appliances that allow surgeries to be guided in real time by MRI imaging;

provision of new and improved surgically implantable appliances (e.g., orthopedic, endodontic, etc.) with mechanical properties compatible with those of bone, low corrosion rate, and good biocompatibility (lack of rejection by human or animal tissue);

provision of new and improved articles configured for use as tools, instruments, and parts used for maintaining, inspecting, modifying, operating, or exploring both man-made and naturally-occurring structures which are internally or externally viewable by MRI; and

provision of new and improved methods of performing medical and dental procedures utilizing the aforementioned instruments and appliances.

Further and other objects of the present invention will become apparent from the description contained herein.

### SUMMARY OF THE INVENTION

In accordance with one aspect of the present invention, the foregoing and other objects are achieved by an article, at least a portion of which includes a bulk metallic glass having magnetic properties suitable for producing an MRI image, the article having a shape suitable for producing an MRI image and being configured for use as a medical instrument and/or a biomedical appliance.

In accordance with another aspect of the present invention, a method of carrying out a medical procedure includes the steps of: providing a medical instrument or a biomedical appliance, at least a portion of which includes a bulk metallic glass; and using the medical instrument or biomedical appliance to carry out a medical procedure.

In accordance with a further aspect of the present invention, a method of carrying out an MRI-guided procedure includes the steps of: providing an article, at least a portion of which includes a bulk metallic glass; and using the article to carry out an MRI-guided procedure.

### BRIEF DESCRIPTION OF THE DRAWINGS

In the drawings:

FIG. 1 is a full-scale MRI image of a 7 mm diameter rod of a conventional copper alloy (Cu-4 Cri-2 Nb) in salt water.

FIG. 2 is a full-scale MRI image of a 7 mm diameter rod of BAM-11 in salt water in accordance with the present invention.

FIG. 3 is a full-scale MRI image of a 7 mm diameter rod of Ni-free BMG in salt water in accordance with the present invention.

FIG. 4 is a full-scale MRI image of a bullet nosed 6 mm diameter rod of Ti-6 Al-4.

FIG. 5 is a full-scale MRI image of a bullet nosed 6 mm diameter rod of BAM-11 in salt water in accordance with the present invention.

FIG. 6 is a view of a typical conventional orthopedic bone screw.

FIG. 7 is a view of an orthopedic bone screw of an improved design made possible by the use of BMG in accordance with the present invention.

For a better understanding of the present invention, together with other and further articles, advantages and capabilities thereof, reference is made to the following disclosure and appended claims in connection with the above-described drawings.

### DETAILED DESCRIPTION OF THE INVENTION

It has been discovered that certain bulk metallic glass (BMG) alloys have a very low MRI signature. BMG materials have high hardness, tensile strength, and toughness. The present invention is based on the discovery that the unique properties of BMG alloys make them especially suitable for biomedical implant applications as well as for medical instruments.

The invention described and claimed herein involves both apparatus and methods for the use of medical instruments and surgically implantable devices made of bulk metallic glasses during surgical and dental procedures in an intervention MRI in which the MRI guides the surgery in real time. The bulk metallic glass has an excellent MRI signature due to its amorphous structure. An accurate signature of the metallic implant or instrument is of paramount importance for accurate position information of the instrument or implant device.

It is recognized that a large range of specific compositions of BMG are known to and may be used by the skilled artisan in this invention. For example, see U.S. Pat. No. 5,735,975 issued on Apr. 7, 1998 to Lin, et al. entitled “Quinary Metallic Glass Alloys” and U.S. Pat. No. 5,803,996 issued on Sep. 8, 1998 to Inoue, et al. entitled “Rod-Shaped or Tubular Amorphous Zr Alloy Made by Die Casting and Method for Manufacturing said Amorphous Zr Alloy”. The patents of both Lin and Inoue are incorporated herein by reference. The specific composition of the alloy used in examples described herein is Zr-17.9 Cu-14.6 Ni-5 Ti-10 Al (at %).

It is further recognized that attempts have been made in the past to provide medical instruments which cause reduced or enhanced artifact on diagnostic images such as MRI images. One such example is U.S. Pat. No. 5,895,401, issued Apr. 20, 1999, “Controlled-Artifact Magnetic Resonance Instruments” by Daum et al. However, Daum teaches a crystalline alloy comprising at least 85% titanium and does not teach an alloy which is amorphous such as the bulk metallic glass taught herein. Conversely, the bulk metallic glass as taught herein contains no more than 12at. % titanium. Thus the present invention and Daum teach grossly different materials.

Because of the unique atomic structure in an amorphous metallic glass, this material possesses unique magnetic properties that allow the excellent MRI signature.

The composition tested contains substantial amounts of a ferromagnetic element, Ni. In a crystalline structure, the presence of Ni produces substantial blooming in an MRI image. All of the other elements in this alloy, namely Zr, Ni, Ti, and Al all have susceptibilities substantially higher than that of human tissues thereby producing a positional error in the MRI image. Only copper has susceptibility similar to human or animal tissues. Comparison images show that the image of the BMG is better even than a copper alloy. All bulk metallic glasses that are not expressly designed for good soft or hard ferromagnetic properties are expected to have this good MRI signature.

BMG alloys have a lower modulus and an extremely high elastic limit of about 2% as compared to that of a typical metal, namely about 0.2%. Bone has an elastic limit of about 1%. BMGs are unique in their ability to flex elastically with the natural bending of bones and so distribute stresses more uniformly. Faster healing rates result from reduced stress shielding effects while minimizing stress concentrators. Because of the unique mechanical properties of the BMGs, screws can have a thinner shank and deeper threads yielding greater holding power. Compared to the lowest modulus developmental titanium alloy, for a given load, the BMG will require ¼ the cross section to carry the load and will undergo twice the deflection. Compared to stainless steel, the area will be ⅓ to carry the load and the BMG will have 5 times the deflection. Potential applications include fracture fixation screws, rods, pins, hip joint wear surfaces and shafts, aneurysm clips, endodontic files and orthodontic arch wires as well as components of devices such as pacemakers, neurostimulators, medicine-metering pumps, and equipment for remotely-viewed microsurgery.

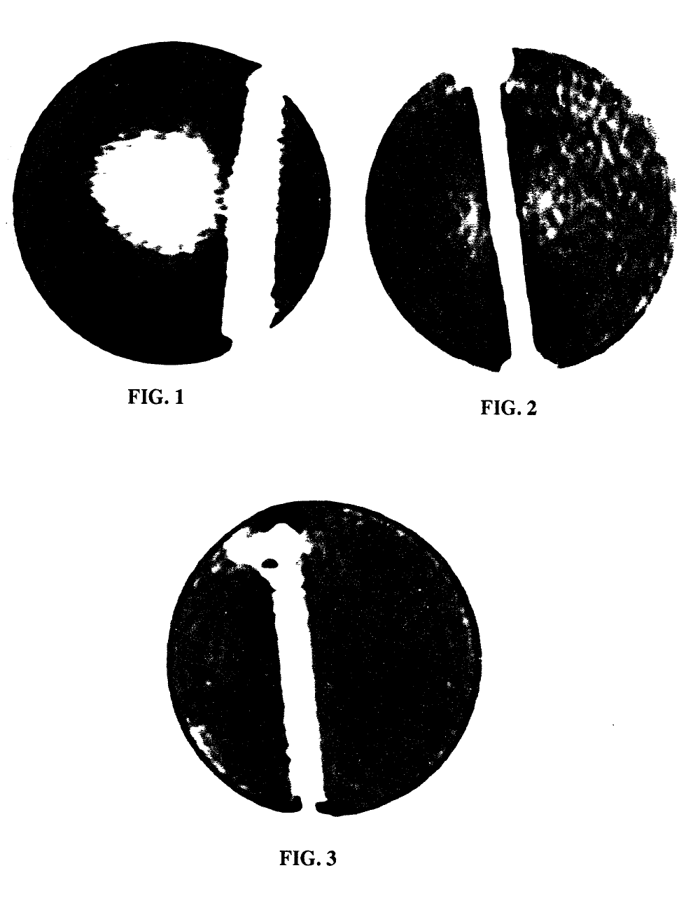

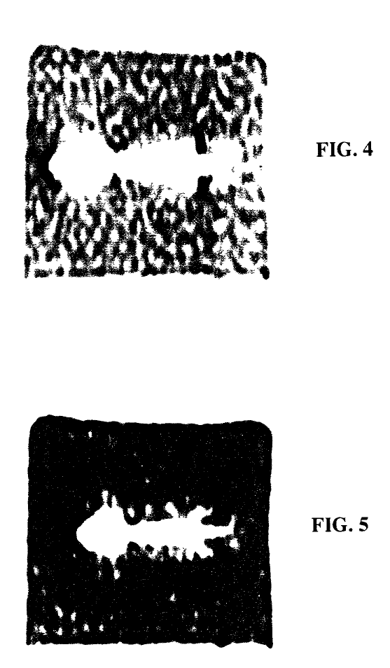

FIGS. 1 and 2 show comparison MRI images of a copper alloy and a BMG alloy (Zr-17.9 Cu-14.6 Ni-5.0 Ti-10.0 Al, referred to here as BAM-11 (all compositions are in atomic %) in a flask of salt water showing much less bloom with the BMG alloy. This is a surprising result, since one would expect the susceptibility to be close to that of zirconium as the major constituent and the nickel in the alloy should make it higher. While copper is the metal with a susceptibility closest to that of living human or animal tissue, it is too soft for many uses, especially medical instruments and implants. The toxicity of beryllium all but prohibits the use of the harder Be—Cu alloys. For these reasons, the unique magnetic properties of BMG materials yield the ability to fabricate MRI-friendly implant devices as well as a new class of medical instruments for use within the interventional MRI environment. Minimally invasive procedures not possible via conventional surgical and dental techniques can be successfully performed through interventional MRI, indicating a critical need for instruments to facilitate these procedures.

Prior to the recent development of these bulk metallic glasses, rapid solidification such as melt spinning or gas atomization producing thin ribbons or powders (<150 mm) was required to achieve the sufficiently high cooling rates necessary for glass formation. Due to their unique amorphous microstructure with a number of different elements present, the BMGs exhibit a number of exceptional properties. For example, alloy BAM-11 has a yield strength of 1900 MPa, an elastic limit of 2 to 2.2%, Young's Modulus of 90 GPa, Vickers hardness of 590 kg/mm2, and a toughness of 55 to 60 MPa√M. Table 1 lists mechanical properties of BMGs and compares them to that of the three most commonly used implant materials and to one of the new low-modulus titanium alloys under development. Table 2 lists some potential applications for BMG alloys.

(Table 1 begins next page)

TABLE 1
Mechanical properties of bulk metallic glass compared to
the three leading implant materials

| | | | | | | Experimen- |
|---|---|---|---|---|---|---|
| | | | | | | tal Ti- |
| | BMG | | Ti-6Al- | | | 35Nb-5 |
| Property | (BAM 11) | Co-Cr | 4V | 316L-CW | Bone | Ta-7 Zr |
| Tensile Yield Strength, MPa | 1900 | 450 | 830 | 690 | Compressive | 547 |
| | | | | | 130-150 | |
| | | | | | (cortical) | |
| Elastic Strain Limit, % | 2-2.2 | 0.18 | 0.67 | 0.34 | 1% | 0.9 |
| Plastic Strain to failure, % | 1 | 8 | 10 | 12 | — | 19 |
| Young's Modulus, GPa | 90 | 248 | 124 | 200 | 17* | 55 |
| Hardness, Vickers, Kg/mm² | 590 | 350-390 | 320 | 365 | — | — |
| Toughness, Mpa m^{1/2} | 55-60 | — | 57 | 100 | — | — |
| Fatigue load for failure at | — | 310 | 520 | 240 | — | 265 |
| 10⁷ cycles, MPa | | | | | | |
| Density, g/cc | 5.9 | 8.5 | 4.4 | 8 | — | — |
| Biocompatibility | Good, | Good/ | Good | Good/ | — | good |
| | initial | questionable | | questionable | | |
| | evaluation | | | | | |
| Magnetic Susceptibility | Very | Probably | Ti is | Austenitic is | Human tissue | Probably |
| | compatible | ferromagnetic | 182 × 10⁻⁶ | 3-6 × 10⁻³ | is −11 to | similar to |
| | | | | CW is | −7 × 10⁻⁶ | Ti |
| | | | | ferromagnetic | | |

*Bone modulus in GPa Cortical Bone˜15, Subchondral Bone^{˜}2, Trabecular Bone ^{˜}0.1

TABLE 2
Summary of potential health field applications for bulk metallic glasses

| | Unique BMG | Critical Propery | |
|---|---|---|---|
| Application | Property | Measurement | Comments |
| Fracture | Lower modulus, | Fatigue, crack | Some plates |
| Fixation and | high strength | initiation at | require plastic |
| Fusion Plates | | drill holes, | deformation to |
| | | corrosion, | adjust fit at time |
| | | biocompatibility | of insertion which |
| | | | BMG could not |
| | | | accommodate. |
| Screws | Toughness, | Fatigue, | Less wear debris |
| | high strength | corrosion, | will lead to less |
| | | biocompatibility | immune system |
| | | | response. |
| Hip joints-wear | Low coefficient | Wear, corrosion, | Less wear debris |
| surface | of friction, | biocompatibility | will lead to less |
| | hardness | | immune system |
| | | | response. |
| Hip joints-shaft | Low modulus | Corrosion, | Lower modulus |
| | | biocompatibility | distributes load |
| | | | better |
| Cutting tools, | Toughness, | Edge holding, | May have longer |
| scalpel, bone | high elastic | susceptibility | life than SS that |
| biopsy | limit, hardness | | quickly dull. |
| osteotome, | | | |
| endodontic | | | |
| files | | | |
| Aneurysm clips | High elastic limit, | Creep, corrosion, | Can do emer- |
| | good MRI | biocompatibility | gency MRI later |
| | signature | | without possible |
| | | | fatal results |
| Orthodontist | High elastic limit, | Processing to | Need to slide in |
| Arch Wires | low coefficient | preform or cast | mounts (hard |
| | of friction | to proper shape | enough to be |
| | | | compatible with |
| | | | ceramic brackets), |
| | | | maintain force |
| | | | over large elastic |
| | | | deformations |
| MRI inter- | Good MRI | Edge holding, | A unique material |
| ventional | signature, | susceptibility | for the next |
| surgical | toughness, | | generation of |
| instruments | hardness | | surgical care in |
| | | | an interventional |
| | | | MRI |

### EXAMPLE I

Initial screening tests on BAM-11 performed at the Biomaterials and Orthopedic Research Department at the University of Mississippi Medical Center have shown biocompatibility comparable to current implant materials. For initial biocompatibility screening, two cell lines were selected: microphage and fibroblast. Because these cell types are key in inflammation and encapsulation processes they are generally predictive of soft tissue biocompatibility. Four analyses of biocompatibility were conducted for each cell type: 1) cellular viability, 2) catalase activity, 3) TNF beta cytokine concentration and 4) lactate dehydrogenase concentration. The results are presented in Table 3.

TABLE 3
Initial Biocompatibility Tests of BAM-11
compared to two control specimens*

| | | Ti, commercially | |
|---|---|---|---|
| | BAM-11 | pure | Polyethylene |
| Macrophage Viability, % | 85 | 90 | 91 |
| Macrophage/Catalase | 18 | 22 | 12 |
| Activity/standardized | | | |
| activity/protein quantity | | | |
| Macrophage/Lactate | 6 | 8 | 6 |
| Dehydrogenase, standardize | | | |
| activity/protein quantity | | | |
| Macrophage/Cytokine, | 19 | 18 | 11 |
| picograms/protein quantity | | | |
| Fibroblast Viability, % | 95 | 90 | 92 |
| survival | | | |
| Fibroblast/Catalase Activity | 9 | 5 | 5.5 |
| standardized activity/protei | | | |
| quantity | | | |
| Fibroblast/Lactate | 6.5 | 4 | 5 |
| Dehydrogenase, standardize | | | |
| activity/protein quantity | | | |

### EXAMPLE II

Screening tests on BAM-11 specimens performed at the Biomaterials and Orthopedic Research Department at the University of Mississippi Medical Center have shown corrosion resistance comparable to current implant materials. All specimens were wet ground with SiC paper, 80, 240, 320, 600, and 1500 grit followed by ultrasonic cleaning in distilled water for 5 min. The titanium was additionally passivated in 40% HNO3 for 30 min according to an ASTM standard. Cyclic polarization tests were conducted on triplicate samples of the alloys in Ringer's solution (9.0 g/L-NaCl, 0.42 g/L-KCl, 0.25 g/L-CaCl₂). Specimens were allowed to reach an open-circuit potential (Ecorr) for a period of one hour. A potential scan increasing at a rate of 0.1667 mV/s (ASTM G5) was then initiated at 100 mV below Ecorr and continued until a current threshold of 1×10-2 A/cm2 was reached. At this point the scan was reversed and decreased in the same rate until Ecorr was reached. The results are presented in Table 4.

TABLE 4
Initial corrosion tests of BAM-11

| Alloy | E_{corr} (mV) | E_{br} (mV) | I_{corr} (na/cm²) |
|---|---|---|---|
| Titanium | −51 ± 6.15 | None recorded | 8.2 ± 3.4 |
| 316L SS | −72.7 ± 20 | 323 ± 66.4 | 14.1 ± 6.7 |
| BAM11 | −228.3 ± 38.6 | −65.3 ± 53.0 | 56.1 ± 32.8 |

While currently used surgically implantable orthopedic appliances contain nickel, we have developed compositions that eliminate nickel due to long-term biocompatibility concerns.

### EXAMPLE III

Alloys with composition of Zr-32.5 Cu-5 Ti-10 Al (at. %) were arc cast into a water-cooled copper mold and as cast were 99% amorphous. FIG. 3 shows an MRI image of this new alloy compared to a Cu alloy (FIG. 1) and the BAM-11 alloy (FIG. 2). It is evident that without Ni an even better MRI image is obtained. This is attributed to both removal of Nickel and the high percentage of amorphous material.

It is believed that removal of the nickel is not necessary for use of the BMGs as instruments and temporary fixation devices such as immobilizing screws. Instruments such as bone biopsy tools, scalpel blades, and the like have been fabricated by well-known, conventional techniques such as casting, machining, laser welding, grinding, and polishing.

Magnetic properties of BMGs are also of interest. One of the first commercial uses of rapidly solidified amorphous metals was the Fe—B based alloy for read-write heads and now transformer cores. The BMGs also have been found to have unusual magnetic properties including a soft magnetic alloy with zero magnetostriction, a hard magnetic alloy with only 30% Fe that does not saturate at 15 Tesla and has the highest ever measured coercivity, 8.4 T, although at liquid helium temperature. In general, the magnetic susceptibility is related to density of electronic states at the Fermi energy. Knowledge of the composition dependence of the susceptibility would provide important input in refining models of the amorphous state through first principles calculations of the electronic structure and hence the Fermi energy density of states. The preliminary result presented here concerning a good MRI image was surprising considering the composition and especially the presence of nickel in the alloy. Actual direct measurements of the magnetic susceptibility by a squid magnetometer yield 109×10-6 for BAM-11 versus 182×10-6 for Ti-6 Al-4 V agreeing with the MRI results.

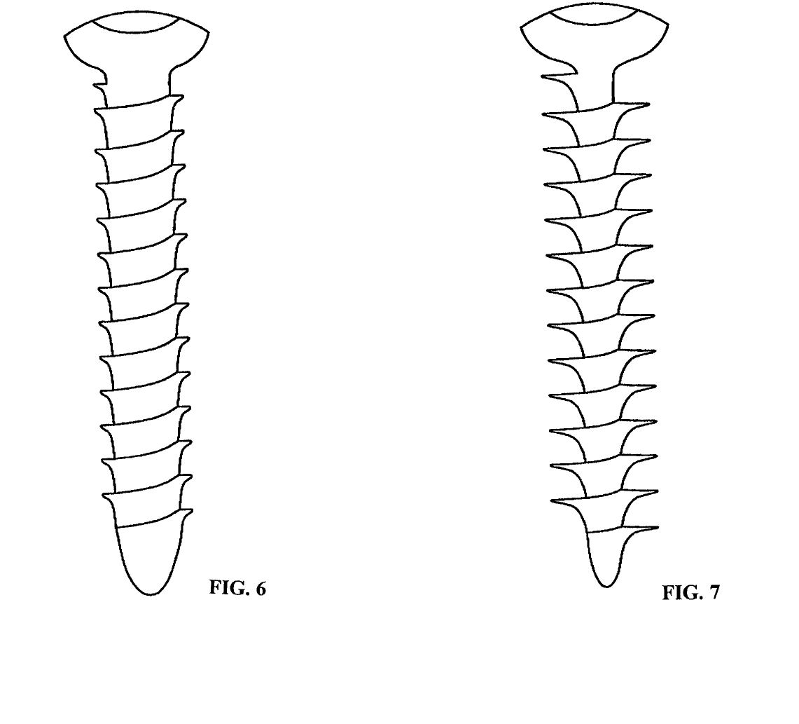

Mechanical properties of the BMG described herein are superior for many surgically implantable appliances and medical instruments than currently used materials. These properties include higher yield strength, higher elastic strain limit, lower Young's modulus (better for reducing stress shielding), higher hardness, and comparable toughness. For example, Because of these unique mechanical properties, screws could have a thinner shank and deeper threads yielding greater holding power. For example, FIG. 6 shows of a typical conventional orthopedic bone screw design, while FIG. 7 shows an orthopedic bone screw of an improved design made possible by the use of BMG in accordance with the present invention.

BMG is uniquely suited for MRI compatible medical instruments and surgically implantable devices because of minimal generation of image distortion. Information readily available from MRI images is critically helpful for many types of surgical procedures. MRI images not only function to guide the surgeon's tools to the location of the procedure along the least damaging path, but also to differentiate and define tissue types for facilitation of more efficient and complete procedures. BMG constructed surgical tools allow for a host of procedures to be performed in the MRI environment. BMG offers the best MRI-compatible cutting instruments available. As such, procedures involving the cutting of bone could be MRI-guided. Examples of such procedures include craniotomy procedures involving tumors, embolisms or strokes and orthopedic procedures involving femoral avascular necrosis and vertebral fusions.

A broad range of other non-medical, even non-biological applications is available to the skilled artisan. Remote viewing and control of diagnostic apparatus and apparatus used to maintain or repair any structure which is viewable using MRI technology is enabled by using instruments and implants constructed of BMG, with minimal invasion of the structure, minimal disturbance of the system the structure functions within, and minimal disruption of processes. Applications might include diagnosis, maintenance, and repair of such structures as electronic structures, composite structures used in aerospace, marine, and other endeavors, or remotely disarming of hazardous structures such as bombs, mines, and other explosives.

It should be noted that ferromagnetic metallic glasses are not suitable for MRI imaging and are specifically excluded from the scope of the present invention. See, for example, U.S. Pat. No. 5,976,274 issued on Nov. 2, 1999 to Inoue, et al. entitled “Soft Magnetic Amorphous Alloy and High Hardness Amorphous Alloy and High Hardness Tool Using the Same” and U.S. Pat. No. 4,653,500 issued on Mar. 31, 1987 to Osada, et al. entitled “Electrocardiographic amorphous alloy electrode”.

While there has been shown and described what are at present considered the preferred embodiments of the invention, it will be obvious to those skilled in the art that various changes and modifications can be made therein without departing from the scope of the inventions defined by the appended claims.

What is claimed is:

1. An article, at least a portion of said article comprising a bulk metallic glass having magnetic properties suitable for producing an MRI image, said article having a shape suitable for producing an MRI image, said article being configured for use as at least one of the group consisting of medical instruments and biomedical appliances.

2. An article in accordance with claim 1 wherein said article is configured to be surgically implanted in a body in a manner wherein said article is viewable on an MRI after implantation.

3. An article in accordance with claim 1 wherein said article is configured to be surgically implanted in a body in a manner wherein said article is viewable on an MRI during implantation.

4. An article in accordance with claim 1 wherein said article is configured for use as a fixation device.

5. An article in accordance with claim 4 wherein said article is configured for use as an orthopedic device.

6. An article in accordance with claim 4 wherein said article is configured for use as an endodontic device.

7. An article in accordance with claim 1 wherein said article is configured for use as a wear surface.

8. An article in accordance with claim 1 wherein at least part of said article is tubular in shape.

9. An article in accordance with claim 8 wherein said article is configured for use as at least one of the group consisting of probe, speculum, stent, needle, syringe, and biopsy device.

10. An article in accordance with claim 1 wherein said article is configured as a casing.

11. A method of carrying out a medical procedure comprising the steps of:
a. providing an article selected from the group consisting of medical instruments and biomedical appliances, at least a portion of said article comprising a bulk metallic glass; and
b. using said article to carry out a medical procedure.

12. A method in accordance with claim 11 wherein said medical procedure is an orthopedic procedure.

13. A method in accordance with claim 11 wherein said medical procedure is an endodontic procedure.

14. A method in accordance with claim 11 wherein said medical procedure comprises an MRI-guided procedure.

15. A method of carrying out an MRI-guided procedure comprising the steps of:
a. providing an article, at least a portion of said article comprising a bulk metallic glass; and
b. using said article to carry out an MRI-guided procedure.

16. A method in accordance with claim 15 wherein said MRI-guided procedure further comprises a medical procedure.

17. A method in accordance with claim 15 wherein said MRI-guided procedure further comprises a non-medical procedure.
